(19) United States
(12) Patent Application Publication
(10) Pub. No.: US 2020/0176944 A1
(43) Pub. Date: Jun. 4, 2020

(54) LASER OSCILLATOR WITH DISPERSED INSTALLATION ROUTE OF OPTICAL FIBER

(71) Applicant: Fanuc Corporation, Yamanashi (JP)

(72) Inventor: Tomohiro Inoue, Yamanashi (JP)

(73) Assignee: Fanuc Corporation, Yamanashi (JP)

(21) Appl. No.: 16/682,248

(22) Filed: Nov. 13, 2019

(30) Foreign Application Priority Data
Nov. 30, 2018 (JP) 2018-225893

(51) Int. Cl. H01S 3/08; G02B 6/24; H01S 3/067; H01S 3/04; H01S 3/00

(52) U.S. Cl. CPC H01S 3/08; G02B 6/24; H01S 3/06708; H01S 3/04; H01S 3/005; H01S 3/06704

(57) ABSTRACT

Provided is a laser oscillator including: in a single housing, a first optical fiber extending from an excitation light source module; a second optical fiber extending from a resonator; and a first plate on which a connection point between the first optical fiber and the second optical fiber is disposed, the first optical fiber and the second optical fiber extending toward the connection point from one side and another side of the first plate, respectively.

### BACKGROUND OF THE INVENTION

### 1. Field of the Invention

The present invention relates to a laser oscillator and more particularly to a laser oscillator with dispersed installation routes of optical fibers.

### 2. Description of the Related Art

Documents below are each known as a related art of an installation route of an optical fiber. JP 2001-68769 A discloses a laser device including a duct between a solid-state laser device and a dye laser device, the duct being provided in its inside with an optical fiber. JP 2017-194497 A discloses an optical fiber fusion splicing structure in which two optical fibers are connected using fusion splicing.

### SUMMARY OF THE INVENTION

A laser oscillator is likely to increase in size due to a placement relationship between components, an allowable bending radius of an optical fiber, and the like. In addition, due to a large number of optical fibers that cannot be installed in one route causing the optical fibers to intersect each other (coming close to each other or coming in contact with each other), there is a problem in that when an optical fiber from a resonator is burned out due to back-reflection or the like during workpiece processing, for example, and secondarily, an optical fiber from an excitation light source module is also involved to end up burning an expensive excitation light source module. Further, a connection point between optical fibers may not be visible from a maintenance side, so efficiency in an examination process and maintenance work has deteriorated.

Thus, there is a demand for a technique that disperses an installation route of an optical fiber in a laser oscillator.

One aspect of the present disclosure provides a laser oscillator having an excitation light source module and a resonator in a single housing, the laser oscillator including: a first optical fiber extending from the excitation light source module; a second optical fiber extending from the resonator; and a first plate on which a connection point of the first optical fiber and the second optical fiber is disposed, wherein the first optical fiber and the second optical fiber extending toward the connection point from one side and another side of the first plate, respectively.

Another aspect of the present disclosure provides a laser oscillator including an excitation light source module and a resonator in a single housing, wherein all connection points between optical fibers in the housing are disposed at a position visible from a maintenance side.

Yet another aspect of the present disclosure provides a laser oscillator having an excitation light source module and a resonator in a single housing, the laser oscillator including: a first optical fiber extending from the excitation light source module; a second optical fiber extending from the resonator; a first plate on which a connection point between the first optical fiber and the second optical fiber is disposed; and a second plate on which the excitation light source module and the resonator are disposed, wherein the first plate and the second plate being disposed in a two layer structure.

### BRIEF DESCRIPTION OF THE DRAWINGS

FIG. 1 is a schematic diagram illustrating a structure of a laser oscillator according to an embodiment.

FIG. 2 is a schematic diagram illustrating a structure of a laser oscillator according to another embodiment.

FIG. 3 is a schematic diagram illustrating a structure of a laser oscillator according to yet another embodiment.

FIG. 4 is a schematic diagram illustrating a structure of a laser oscillator according to still yet another embodiment.

FIG. 5 is a schematic diagram illustrating a structure of a laser oscillator of a comparative example.

### DETAILED DESCRIPTION

Embodiments of the present disclosure will be described in detail below with reference to the accompanying drawings. In the drawings, identical or similar constituent elements are given identical or similar reference signs. Additionally, the embodiments described below are not intended to limit the technical scope of the invention or the meaning of terms set forth in the claims.

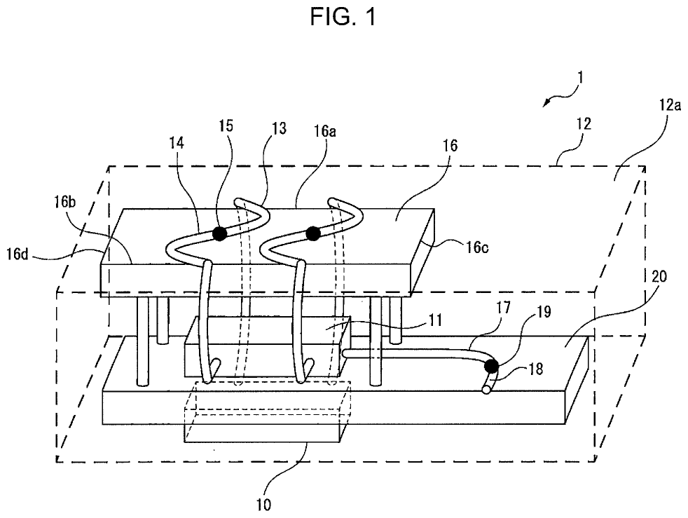

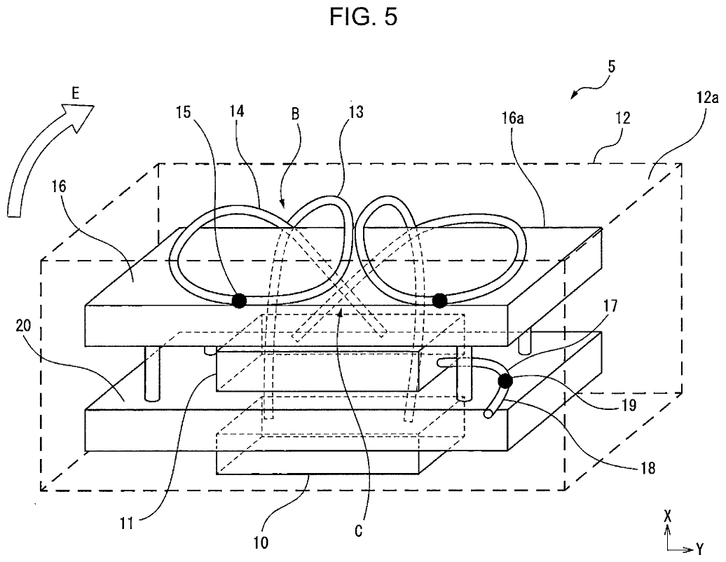

FIG. 1 is a block diagram illustrating a structure of a laser oscillator 1 according to an embodiment. The laser oscillator 1 includes an excitation light source module 10 and a resonator 11 in a single housing 12. The excitation light source module 10 and the resonator 11 are connected to each other using a first optical fiber 13 and a second optical fiber 14. The first optical fiber 13 extends from the excitation light source module 10, and the second optical fiber 14 extends from the resonator 11. A connection point 15 between the first optical fiber 13 and second optical fiber 14 is disposed on a first plate 16. While only two sets of the first optical fiber 13 and the second optical fiber 14 are representatively illustrated in the present example, there is also a structure with many sets thereof, such as three or four sets. The first optical fiber 13 and the second optical fiber 14 are disposed extending from one side 16a and another side 16b of the first plate 16, respectively, to the connection point 15. This structure allows installation routes of the first optical fiber 13 and the second optical fiber 14 to be dispersed to prevent the optical fibers from intersecting each other (neither coming close to each other nor coming in contact with each other), as compared to an installation route of the first optical fiber 13 and the second optical fiber 14 from the same side of the first plate 16 (e.g., the side 16a) to the connection point 15 (refer to FIG. 5). Thus, secondary burnout of the expensive excitation light source module 10 can be prevented.

The laser oscillator 1 of the present example further includes a third optical fiber 17 extending from the resonator 11, and a fourth optical fiber 18 extending outward of the housing 12. The third optical fiber 17 is connected to the fourth optical fiber 18, and a connection point 19 between the third optical fiber 17 and the fourth optical fiber 18 is disposed on a second plate 20. The laser oscillator 1 has a structure (e.g., a detachable cover, a maintenance window, and the like) that allows maintenance from an upper surface 12a side (maintenance side) of the housing 12, and the connection points 15 and 19 (including other connection points) between the corresponding optical fibers in the housing 12 are each disposed in a position visible from the maintenance side. Specifically, when the first plate 16 is disposed closer to the maintenance side than the second plate 20 and the first plate 16 is formed having a surface area less than a surface area of the second plate 20, the connection point 15 on the first plate 16 and the connection 19 on the second plate 20 are visible from the maintenance side. This structure enables an examination process and maintenance work of the laser oscillator 1 to be efficiently performed.

In the laser oscillator 1 of the present example, the excitation light source module 10 and the resonator 11 are disposed on the second plate 20, and the first plate 16 and the second plate 20 are disposed in a two-layer layer structure. In addition, the excitation light source module 10 and the resonator 11 are disposed on a front surface and a back surface of the second plate 20, respectively. Accordingly, the laser oscillator 1 can be further downsized.

The laser oscillator 1 of the present example further includes a cooling device (not illustrated) configured to cool the second plate 20 to simultaneously cool the excitation light source module 10 and the resonator 11 on the second plate 20. Examples of the cooling device include known chillers such as a water-cooled type, air-cooled type, and the like.

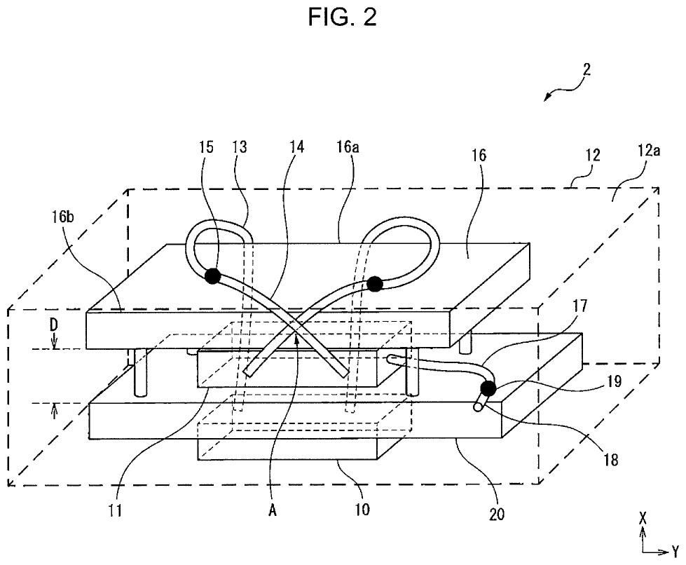

FIG. 2 is a schematic diagram illustrating a structure of a laser oscillator 2 according to another embodiment. The laser oscillator 2 of the present example is different from the embodiment described above in that second optical fibers 14 are each inclined with respect to a vertical direction X, in a route from the first plate 16 toward the resonator 11. This structure reduces a distance D between the first plate 16 and the second plate 20 to less than that of the embodiment described above, so that the laser oscillator 2 can be further downsized. At a point A in a route from the first plate 16 toward the resonator 11, the second optical fibers 14 intersect with each other (coming close to each other but being not in contact with each other); however, the first optical fiber 13 and the second optical fiber 14 do not intersect each other (neither coming close to each other nor coming in contact with each other). Thus, even when the second optical fiber 14 from the resonator 11 is burned out due to back-reflection or the like during workpiece processing, the first optical fiber 13 from the excitation light source module 10 is not involved in the second optical fiber 14. As a result, secondary burnout of the expensive excitation light source module 10 can be prevented.

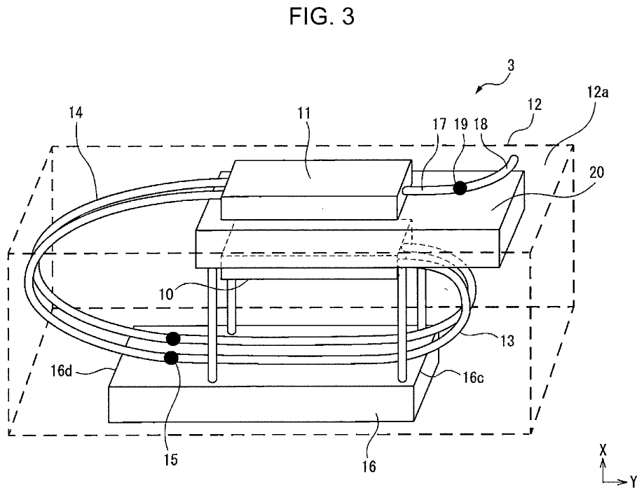

FIG. 3 is a schematic diagram illustrating a structure of a laser oscillator 3 according to yet another embodiment. The laser oscillator 3 of the present example is different from the embodiment described above in that the first plate 16 and the second plate 20 are disposed at opposite positions in the vertical direction X. Specifically, the second plate 20 is disposed closer to a maintenance side (the upper surface 12a side) than the first plate 16. The first plate 16 and the second plate 20 each have a substantially equal area but may each have a different area. The first plate 16 and the second plate 20 are displaced from each other in a horizontal direction Y, so that all of the connection points 15 and 19 (including other connection points) between optical fibers in the housing 12 are visible from the maintenance side.

Even in the laser oscillator 3 of the present example, the first optical fiber 13 and the second optical fiber 14 are disposed extending from one side 16c and another side 16d of the first plate 16, respectively, to the connection point 15. As a result, installation routes of the first optical fiber 13 and the second optical fiber 14 are dispersed to prevent the first optical fiber 13 and the second optical fiber 14 from intersecting each other (neither coming close to each other nor coming in contact with each other). Thus, secondary burnout of an expensive excitation light source module 10 can be prevented.

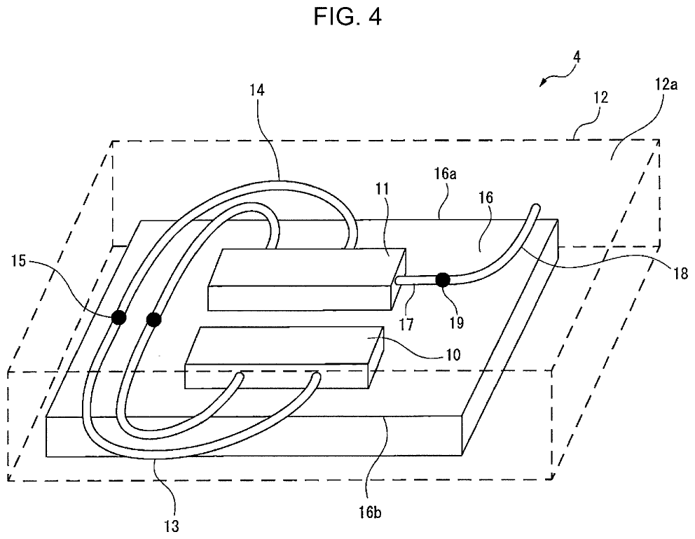

FIG. 4 is a schematic diagram illustrating a structure of a laser oscillator 4 according to still yet another embodiment. The laser oscillator 4 of the present example is different from the embodiment described above in that all components are disposed only on the first plate 16, so the laser oscillator 4 can be further thinned. As in the embodiment described above, the first optical fiber 13 and the second optical fiber 14 are disposed extending from the one side 16a and the other side 16b of the first plate 16, respectively, to the connection point 15, so that installation routes of the first optical fiber 13 and the second optical fiber 14 are dispersed to prevent the first optical fiber 13 and the second optical fiber 14 from intersecting each other (neither coming close to each other nor coming in contact with each other). Thus, secondary burnout of an excitation light source module 10 can be prevented. At the same time, all of the connection points 15 and 19 (including other connection points) between optical fibers in the housing 12 are each disposed at a position visible from a maintenance side, so that efficiency of an examination process and maintenance work of the laser oscillator 3 is also improved.

FIG. 5 is a schematic diagram illustrating a structure of a laser oscillator 5 of a comparative example. The laser oscillator 5 of the comparative example is different from the embodiment described above in that the first optical fibers 13 and second optical fibers 14 are disposed extending from the same side 16a of the first plate 16 to the respective connection points 15. To downsize the laser oscillator 5, each of the second optical fibers 14 is inclined with respect to the vertical direction X in a route from the first plate 16 toward the resonator 11. Thus, the first optical fibers 13 and the corresponding second optical fibers 14 intersect each other (coming close to each other or coming in contact with each other) at respective points B in routes toward the corresponding connection points 15. The second optical fibers 14 themselves also intersect each other (coming close to each other or coming in contact with each other) at a point C in the routes toward the corresponding connection points 15. At the point C, the second optical fibers 14 themselves intersect each other, so that only the resonator 11 may be burned out. However, when the second optical fibers 14 are burned out at the corresponding points B, the first optical fibers 13 extending from the excitation light source module 10 are also involved, and thus the expensive excitation light source module 10 may be burned out secondarily.

In addition, the laser oscillator 5 of the comparative example is configured such that the first plate 16 has an area substantially equal to an area of the second plate 20 and that the first plate 16 and the second plate 20 are not displaced from each other in the horizontal direction Y. Thus, the connection point 19 between the third optical fiber 17 and the fourth optical fiber 18 is not disposed at a position visible from a maintenance side (upper surface 12a side). This structure requires a structure and a process for opening the first plate 16 (e.g., a hinge or a process for opening it in the direction of the arrow E) in an examination process and maintenance work of the laser oscillator 5, so the number of parts as well as the number of processes increases. In addition, when the first plate 16 is opened and closed, the first optical fibers 13 and the second optical fibers 14 intersecting each other (coming close to each other) at the respective points B are likely to come into contact with each other, and secondary damage to the expensive excitation light source module 10 is also likely to occur.

Although some embodiments have been described in this specification, the present invention is not limited to the above-described embodiments, and it is to be understood that various changes can be made without departing from the scope of the appended claims.

1. A laser oscillator having an excitation light source module and a resonator in a single housing, the laser oscillator comprising:
a first optical fiber extending from the excitation light source module;
a second optical fiber extending from the resonator; and
a first plate on which a connection point between the first optical fiber and the second optical fiber is disposed,
wherein the first optical fiber and the second optical fiber extending toward the connection point from one side and another side of the first plate, respectively.

2. The laser oscillator of claim 1, wherein
all connection points between optical fibers in the housing are disposed at a position visible from a maintenance side.

3. The laser oscillator of claim 2, further comprising:
a second plate on which the excitation light source module and the resonator are disposed,
wherein the first plate and the second plate are disposed in a two-layer structure.

4. The laser oscillator of claim 3, wherein
the excitation light source module and the resonator are disposed on a front surface and a back surface of the second plate, respectively.

5. The laser oscillator of claim 3, further comprising:
a cooling device configured to cool the second plate.

6. The laser oscillator of claim 3, wherein
the first plate is disposed closer to the maintenance side than the second plate, and
the first plate has a surface area less than a surface area of the second plate.

7. The laser oscillator of claim 3, wherein
the first plate is disposed closer to the maintenance side than the second plate, and
the first plate and the second plate are displaced from each other in a horizontal direction.

8. A laser oscillator comprising:
an excitation light source module and a resonator in a single housing,
wherein all connection points between optical fibers in the housing are disposed at a position visible from a maintenance side.

9. A laser oscillator having an excitation light source module and a resonator in a single housing, the laser oscillator comprising:
a first optical fiber extending from the excitation light source module;
a second optical fiber extending from the resonator;
a first plate on which a connection point between the first optical fiber and the second optical fiber is disposed; and
a second plate on which the excitation light source module and the resonator are disposed,
wherein the first plate and the second plate being disposed in a two-layer structure.
